(19) United States
(12) Patent Application Publication
(10) Pub. No.: US 2011/0062070 A1
(43) Pub. Date: Mar. 17, 2011

(54) APPARATUS FOR TREATING WASTEWATER, PARTICULARLY WASTEWATER ORIGINATING FROM A PROCESS FOR THE PRODUCTION OF PHOTOVOLTAIC CELLS

(76) Inventors: Ferdinando Martini, Caldogno (IT); Gianluca Castelli, Campodarsego (IT); Franco Traverso, Carmignano Di Brenta (IT); Andrea Ragni, Vicenza (IT)

(21) Appl. No.: 12/736,836

(22) PCT Filed: May 14, 2009
(86) PCT No.: PCT/EP2009/055871

§ 371 Date: Nov. 15, 2010

(30) Foreign Application Priority Data
May 15, 2008 (IT) PD 2008 A 000143

(51) Int. Cl. C02F 1/00

(52) U.S. Cl. 210/196; 210/323.1; 210/332

(57) ABSTRACT

An apparatus for the treatment of wastewater, particularly wastewater originating from a process for the production of photovoltaic cells, comprising:
a first line for the treatment of wastewater originating from the process, with a high level of acidity,
a second line for the treatment of wastewater with a low level of acidity,
a third line for the treatment of wastewater with a very low level of acidity,
a fourth line for the treatment of alkaline wastewater,
the wastewater that exits from the second line and the third line being adapted to be sent to a purification line designed for filtering, obtaining pure water and ultrapure water, ready to be reused in the same production process.

The present invention relates to an apparatus for the treatment of wastewater, particularly wastewater originating from a process for the production of photovoltaic cells or the like.

### BACKGROUND OF THE INVENTION

Currently, a process for the production of photovoltaic cells based on crystalline silicon consumes extremely large amounts of water and generates wastewater with a high content of dangerous components, i.e., components that are harmful for people and the environment.

Currently known systems for treating wastewater in this field are aimed generally at converting wastewater with a lower level of acidity and wastewater with a very low level of acidity so as to lower their content of pollutants below the limit set by local laws for discharge into a sewage system.

This reduction of the content of pollutants, among which the most harmful are fluorides, must be even greater if, due to lack of sewage systems, discharge into surface water (river, ditch, or the like) is wanted or needed.

Experience teaches that possessing or not the requirements for discharging into a sewage system or into surface water can become a discriminating parameter between the survival and the failure of a company that manufactures photovoltaic cells, since the obligation to remove the stored wastewater that cannot be discharged, in order to have it disposed by specialized third-party companies, can cause cost items, as well as the substantial slowing of the production rates of a cell production line which may endanger the market strength of such manufacturing company.

For example, currently in a line for the production of photovoltaic cells equivalent to 30 MW/year, the wastewater in output to be treated has an average flow-rate of approximately 5 m³ per hour.

This entails, in addition to an enormous expenditure of water resource, also enormous volumes of wastewater to be stored and disposed if the limits set by local applicable statutory provisions are not attained; taking also into account the fact that in currently known wastewater treatment apparatuses at least part of the wastewater that can be treated is processed with reverse-osmosis systems, which generally have an efficiency of 50%, i.e., require 2 cubic meters of mains or well water for the production of 1 cubic meter of osmotized water.

Moreover, any acid wastewater current with concentrations of salts higher than 200 ppm must be collected, stored and disposed at an authorized company and organized for the treatment of such wastewater.

Another limitation of currently known apparatuses for the treatment of wastewater that originates from a process for the production of photovoltaic cells is linked to the fact that traditional treatment systems work effectively when the wastewater is concentrated with pollutants; the wastewater that a cell production line produces instead has a relatively low pollutant load; this low concentration of free ions in the solution entails a low probability that they will bind and precipitate, separating out of the solution: accordingly, large quantities of chemical substances are required in order to ensure good suppression.

These known treatment apparatuses, therefore, entail a consumption of additional chemical substances useful for purifying the water, which are different from the ones already used for the cell production line, with a huge increase in the amount of sludge to be disposed.

These known treatment apparatuses entail, as mentioned, a further consumption of water in addition to the already high consumption needed for the operation of the cell production process, especially due to the reverse osmosis systems.

All this substantially entails, for the cell manufacturing company, that it is impossible to optimize the water resource, and also entails the need to dispose of a considerable quantity of toxic and noxious wastewater at dedicated external companies, with consequent environmental dangers due to the large volume of wastewater transported on road vehicles.

### SUMMARY OF THE INVENTION

The aim of the present invention is to provide an apparatus for treating wastewater, particularly wastewater originating from a process for the production of photovoltaic cells or the like, that is capable of obviating the above-mentioned drawbacks of known types of treatment apparatus.

Within this aim, an object of the present invention is to provide an apparatus that allows to save on mains water.

Another object of the present invention is to provide an apparatus that allows to reduce the environmental impact of the associated process for the production of photovoltaic cells, making it feasible in a manner that is substantially independent of any restrictive local laws or other environmental constraints.

Another object of the present invention is to provide an apparatus that reduces the toxic waste to be removed at companies specialized in disposal.

Another object of the present invention is to provide an apparatus that is capable of recovering water from wastewater for subsequent uses within the same production process or within the same treatment apparatus.

Another object of the present invention is to provide an apparatus for treating wastewater, particularly originating from a process for the production of photovoltaic cells or the like, that can be produced with known machines systems and technologies.

This aim and these and other objects, which will become better apparent hereinafter, are achieved by an apparatus for the treatment of wastewater, particularly wastewater originating from a process for the production of photovoltaic cells or the like, characterized in that it comprises:
a first line for the treatment of wastewater originating from said process, with a high level of acidity (AWC),
a second line for the treatment of wastewater with a low level of acidity (AWD),
a third line for the treatment of wastewater with a very low level of acidity (AWDD),
a fourth line for the treatment of alkaline wastewater (CAWC),

the wastewater that exits from said second and third lines being adapted to be sent to a purification line designed for filtering, obtaining pure water and ultrapure water, said pure water and said ultrapure water being adapted to be reused in the same production process from which said wastewater originates, in the associated exhaust gas suppression systems, and in other similar systems.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a diagram of an apparatus according to the invention;

FIG. 2 is a detailed diagram of a first line of the apparatus according to the invention;

FIG. 3 is a detailed diagram of a second line of the apparatus according to the invention;

FIG. 4 is a detailed diagram of a third line of the apparatus according to the invention;

FIG. 5 is a more detailed diagram of a fourth line of the apparatus according to the invention;

FIG. 6 is a more detailed diagram of a purification line of the apparatus according to the invention;

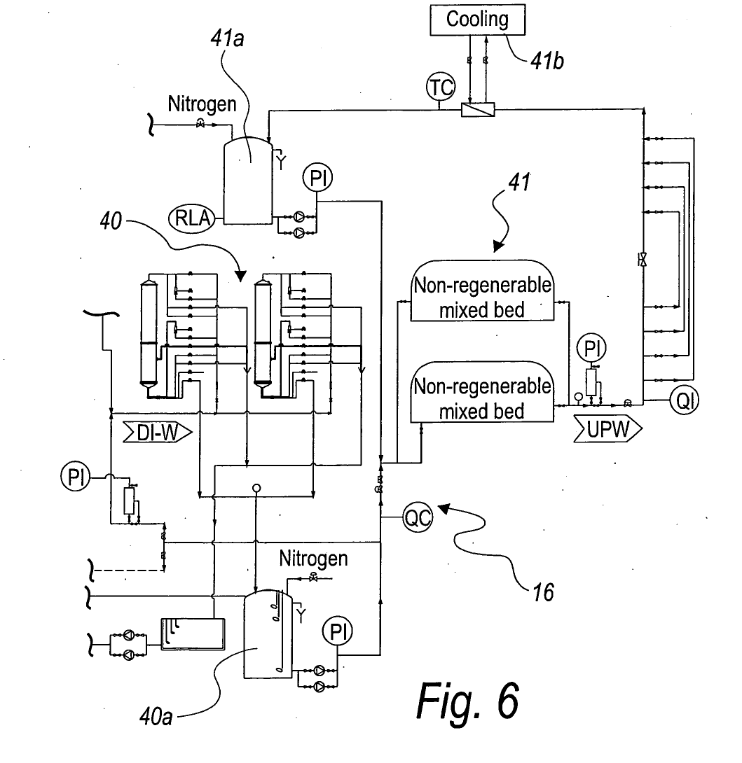

FIG. 7 is a diagram of an associated distillation system.

### DESCRIPTION OF THE PREFERRED EMBODIMENTS

With reference to the figures, an apparatus for the treatment of wastewater, particularly wastewater originating from a process for the production of photovoltaic cells or the like according to the invention, is generally designated by the reference numeral 10.

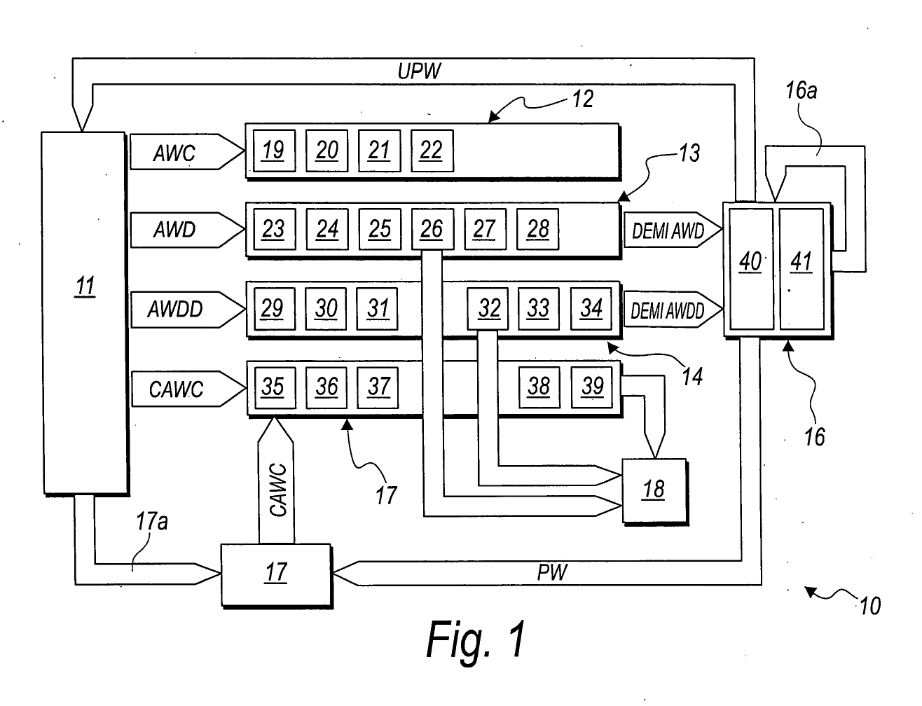

The apparatus 10 comprises:
a first line, shown schematically by the block 12 in FIG. 1, for the treatment of wastewater with a higher level of acidity, designated in FIG. 1 as AWC (Acid Waste Concentrated), originating from a process 11 for example but not exclusively for the production of photovoltaic cells,
a second line 13 for the treatment of wastewater with a low level of acidity AWD (Acid Waste Diluted),
a third line 14 for the treatment of wastewater with a very low level of acidity AWDD (Acid Waste Double Diluted),
a fourth line 15 for the treatment of alkaline wastewater CAWC (Caustic Waste Concentrated).

The wastewater that exits from the second line 13 and the third line 14 is adapted to be sent to a purification line 16, which is designed for filtration, obtaining pure and ultrapure water.

Such pure water (PW) and such ultrapure water (UPW) are reused in the same production process 11 from which such wastewater originates, in the associated exhaust gas suppression systems 17 and in other similar systems.

The exhaust gases that exit from the production process 11 are designated by the reference numeral 17a in FIG. 1.

Part of the pure and ultrapure water is reused in the same purification line 16; these flows are shown schematically by the arrow 16a.

The apparatus 10 according to the invention advantageously also comprises means for the disposal of solid waste 18.

Such means for disposal of solid waste 18 are constituted preferably by a filter press of a per se known type.

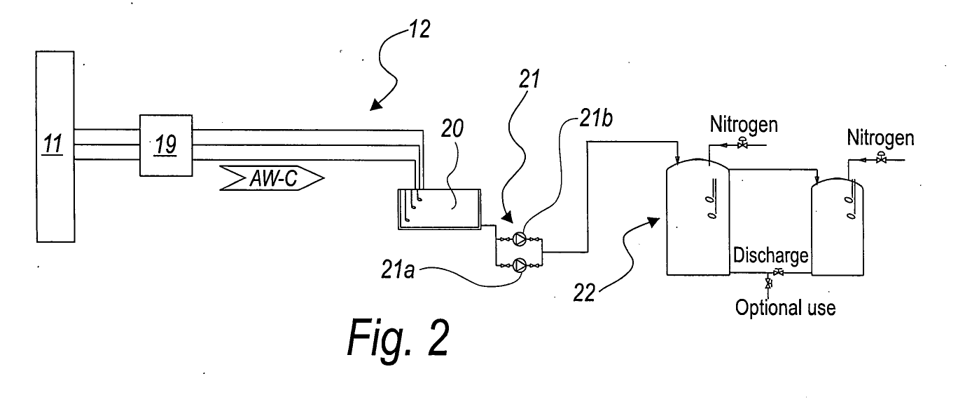

The first line 12 for the treatment of AWC wastewater with a high level of acidity is shown schematically in greater detail in FIG. 2.

The first line 12 comprises:
first means 19 for collecting such wastewater in a first recirculation trap 20,
first means 21 for pumping toward first storage tanks 22,
means for transferring such current with a high level of acidity AWC toward at least one of the other lines, the second one 13, the third one 14, and the fourth one 15.

The first collection means 19 are constituted by the pumps that are dedicated to such wastewater and are associated with each machine of the cell production line; such pumps are powerful enough to recirculate the current within discharge ducts arranged advantageously above the false ceiling of the enclosed space and just below the roof of the factory.

The wastewater is sent into a large-diameter duct (90 mm), which is conveniently inclined toward the first recirculation trap 20, so that the line is never pressurized: only the force of gravity is used to transport the wastewater.

The first pumping means 21 are constituted by two pumps 21a and 21b, so as to ensure redundancy in cases of anomaly or maintenance.

The first line 12 is designed both for storing an AWC current in case of external disposal and for reuse within the same apparatus 10. In any case, therefore, it is possible to continue production activity even if the system is unable to reuse such current.

Thanks to its high level of residual acidity (>0.5%), such AWC wastewater current can be reused in the apparatus 10 in two different fields:
for steps for acidification of the reactor for a chemical physical treatment, described hereafter: instead of fresh sulphuric acid, such acid wastewater is used as it arrives from the first line 12;
for steps for regeneration of the demineralization means, also described hereafter (in particular only for cationic resins) as a replacement of fresh hydrochloric acid: in this case, the AWC current must be filtered appropriately in order to eliminate any silicates that might be present in the wastewater.

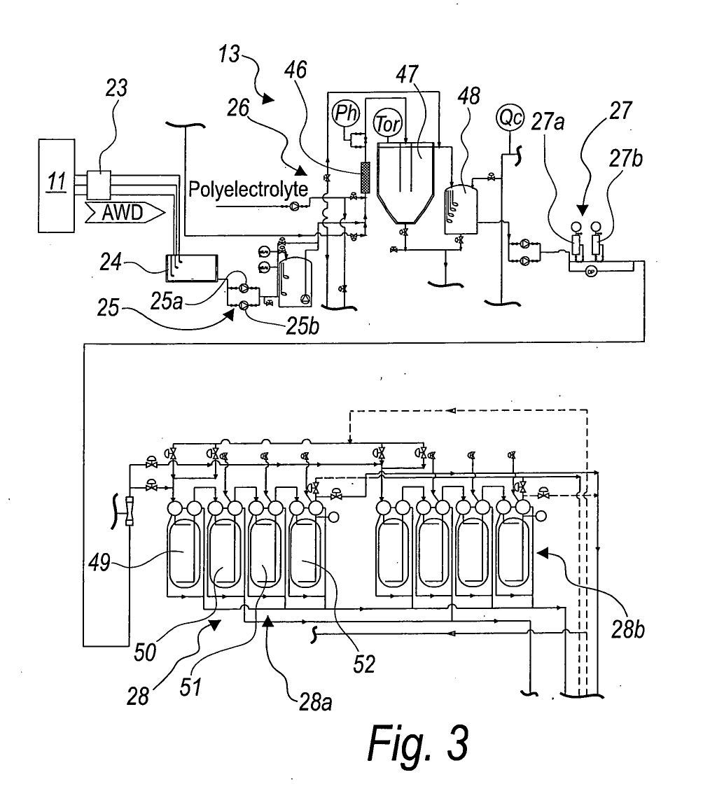

The second line 13 for the treatment of AWD wastewater with a low level of acidity, shown schematically in FIG. 3, comprises
second means 23 for collecting such wastewater in a second recirculation trap 24,
second means 25 for pumping toward first clarification means 26,
first filtering means 27,
first demineralization means 28.

The second collection means 23, in a manner similar to what has been described above for the first line 12, are constituted by pumps dedicated to such AWD wastewater, designed to recirculate the current inside the discharge ducts arranged above the false ceiling and just below the roof of the factory.

The AWD wastewater is sent into a large-diameter duct (90 mm), which is appropriately inclined toward the second recirculation trap 24, so that the line is never pressurized; the duct is made of PVC and does not have a containment channel.

The second trap 24 is part of the system for recirculating the wastewater toward the first step of the treatment, i.e., the clarification means 26.

The second line 13 has a double recirculation pump 25a and 25b so as to ensure redundancy in case of anomaly or maintenance.

Thanks to a twin-scale conductivity meter arranged directly after the pumps 25a and 25b, the salt content of the wastewater produced by the second line 13 can be controlled: the system is therefore capable of giving continuous feedback also to production.

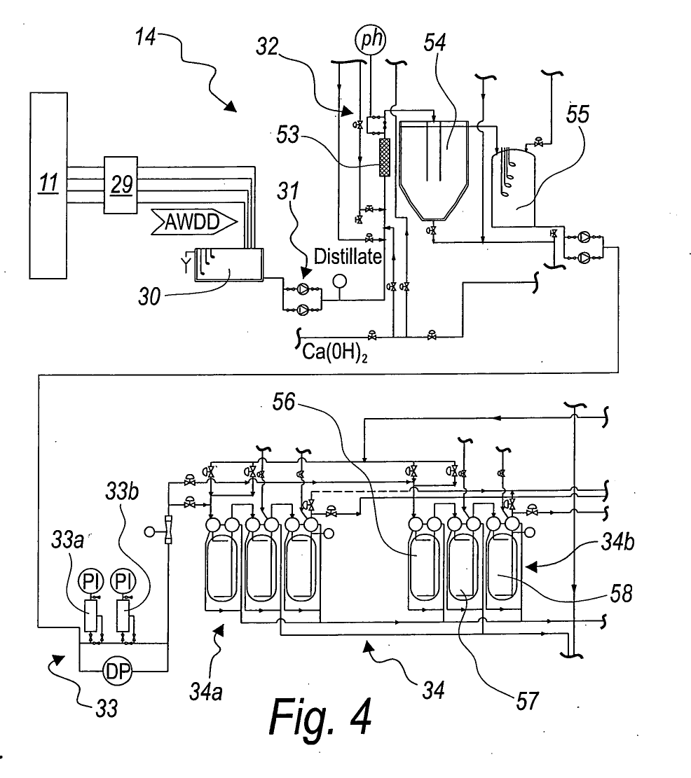

The third line 14 for the treatment of AWDD wastewater with a very low level of acidity, shown schematically in detail in FIG. 4, comprises:
third means 29 for collecting such wastewater in a third recirculation trap 30, fully similar to the ones described above for the first line 12 and the second line 13,
third pumping means 31, which are similar to the corresponding ones described above, for pumping toward second clarification means 32,
second filtration means 33,
second demineralization means 34.

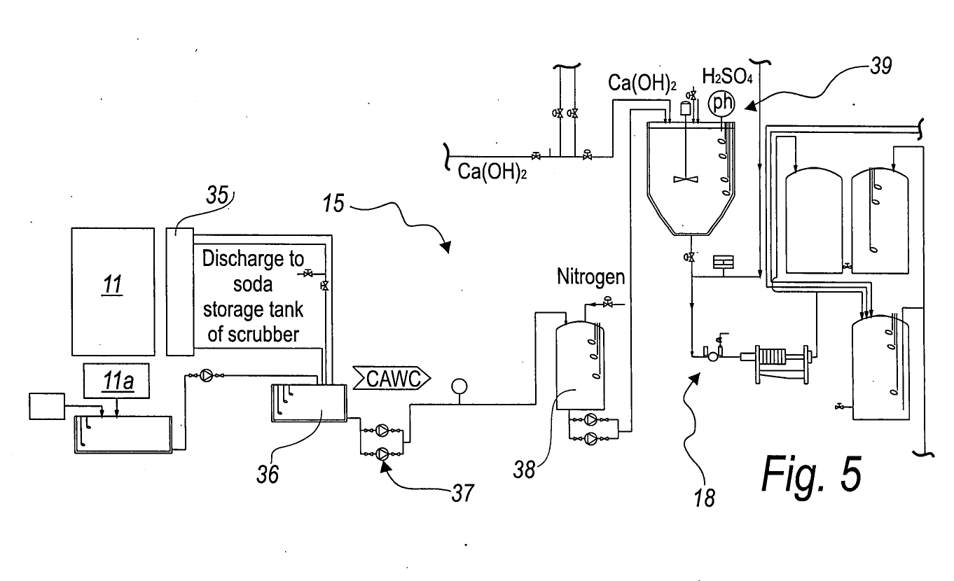

The fourth line 15 for the treatment of CAWC alkaline wastewater, shown schematically in FIG. 5, comprises:
fourth means 35 for collecting such wastewater in a fourth recirculation trap 36,
fourth means 37 for pumping toward at least one storage tank 38,
means 39 for a chemical physical treatment for purifying the stored wastewater.

The wastewater treated by the fourth line 15 also comprises the wastewater that arrives from all the auxiliary apparatuses, designated by the reference numeral 11a in FIG. 5.

In view of the impurity and variability in terms of pollutants of such wastewater, the decision has been made to keep the CAWC wastewater discharge pipes separate with respect to the current that arrives from the so-called SDE line: it is possible to reuse the current that arrives only from the SDE line as an alkaline additive (instead of soda) in the wet scrubber for exhaust gas suppression.

The purification line 16 of the water that exits from such demineralization means 28 and 34 comprises a regenerable mixed-bed system 40 with which a non-regenerable mixed-bed system 41 is associated in series, such systems being both of a per se known type.

The regenerable mixed-bed system 40 is termed in this way because it is possible to reconstitute the resins by means of the regeneration process.

For the sake of redundancy, there are two columns, one in use and one in standby (or in regeneration).

Part of the pure water that exits from the regenerable mixed-bed system 40 goes toward the non-regenerable mixed bed 41 and part goes to keeping wet both the resins of the regenerable mixed bed and the resins of the demineralization means that are in standby (already regenerated).

The pure water in output from the regenerable mixed beds 40 is stored in a first tank 40a and kept under nitrogen blanketing.

The water in output from the regenerable mixed bed 40 has an average conductivity of 0.06-0.15 μS/cm and it is referenced with the term “pure water” (PW).

The water that exits from the regenerable mixed-bed system 40 is sent to the non-regenerable mixed-bed system 41.

Typically, a non-regenerable mixed bed has an efficiency similar to a regenerable one in terms of mass exchange but higher in terms of final purity.

For the sake of redundancy, there are two columns, one in use and one in standby or in regeneration.

Downstream of the non-regenerable mixed beds 41 there is a second tank 41a made of stainless steel with nitrogen blanketing, whereas all the pipes where the ultra pure water (UPW) flows are made of PVDF.

The water in output from the regenerable mixed bed has an average resistivity of 15-18 MOhm/cm.

This water is referenced by the term “ultrapure water”. The circuit for recirculation of the ultrapure water is always kept in motion: stagnant water tends to lose its purity properties.

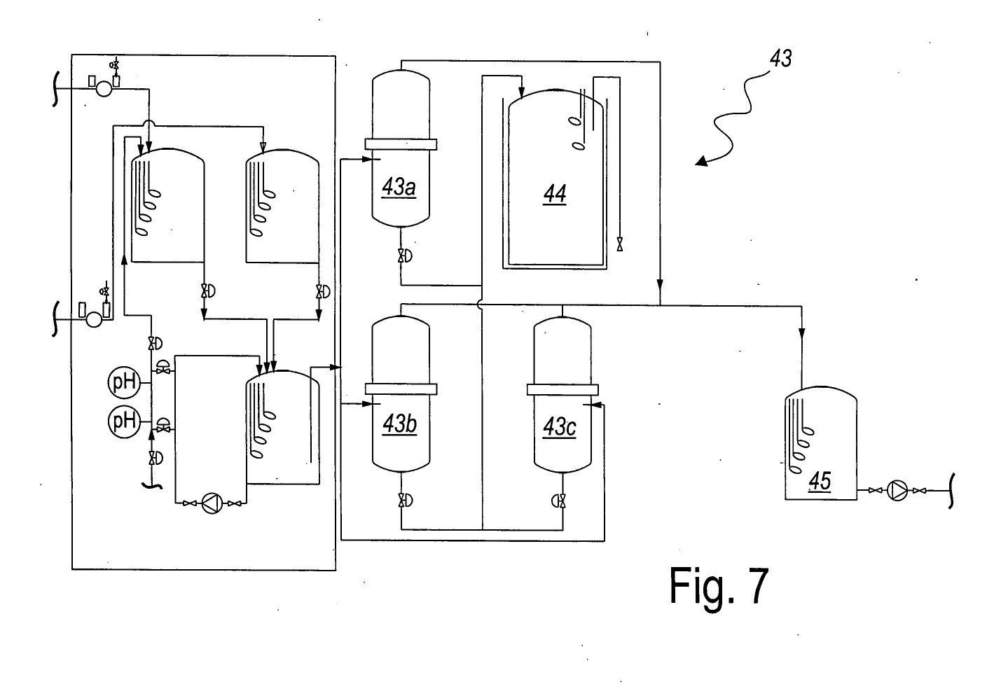

Such circuit is kept cold by means of a heat exchanger 41b. The apparatus 10 according to the invention advantageously comprises means, not shown for the sake of simplicity, for preparing and distributing a polyelectrolyte, means for preparing and distributing milk of lime, and distillation means 43, these last being shown schematically in FIG. 7.

The distillation means 43 are constituted by a series of evaporators 43a, 43b, 43c with which a discharge tank 44 is associated for the concentrates that exit from the evaporators 43a, 43b, 43c, a system for controlling the alkalinity of the solution in input to the distillation means 43, and an additional tank for storing the distilled water 45. The distilled water 45 that exits from the distillation means 43 is designed to be sent advantageously:
upstream of the clarification means 26, 32 of the low-acidity wastewater AWD and very low-acidity wastewater AWDD,
to the means for preparing a polyelectrolyte,
to the means for preparing milk of lime.

The first clarification means 26, whose purpose is to make some of the salts that are present in the current settle to the bottom, in addition to reducing the TSS of the current before the filters, are provided by a first static mixer 46, which has in series in output a first settling tank 47, followed by a storage tank 48 for the clarified fluid that exits from the settling tank, the sediment deposited on the bottom of such settling tank being adapted to be sent to such filter press.

The first filtration means 27, downstream of the first settling tank 47, are constituted by a group of at least two filters 27a, 27b, each of which can be bypassed autonomously with respect to the other, with 20-μ and 5-μ cartridges in series.

The first demineralization means 28 for such low-acidity AWD current, clarified and filtered, are constituted by two assemblies with four transit stages in series 28a, 28b, of which one is active and the other one is in regeneration or standby alternately.

Each assembly 28a, 28b comprises a first stage, which is constituted by a first column with activated charcoal 49, followed by a second stage formed by a second column with cationic resins 50, followed by a third stage constituted by a third column with weak anionic resins 51, followed by a fourth stage constituted by a fourth column 52 that contains strong anionic resins.

Likewise, the second clarification means 32 of the third line 14 are constituted by a second static mixer 53, which has in series in output a second settling tank 54, followed by a tank 55 for storing the clarified fluid that exits from the settling tank 54, the sediment deposited on the bottom of such settling tank being adapted to be sent to such filter press.

The second filtration means 33, downstream of the second settling tank 54, are constituted by an assembly of at least two filters 33a, 33b, each of which can be bypassed autonomously with respect to the other, with 20-μ and 5-μ cartridges in series.

The second demineralization means 34 for the current with very low acidity AWDD, clarified and filtered, are constituted by two assemblies with three transit stages in series 34a, 34b, of which one operates and the other one is in regeneration or standby alternately.

Each one of the two assemblies 34a and 34b comprises a first stage constituted by a first column 56 with an activated charcoal bed, which can be modified with activated alumina, followed by a second stage constituted by a second column with cationic resins 57, followed by a third stage constituted by a third column with weak anionic resins 58.

The means 39 for chemical physical treatment for purifying the stored wastewater are constituted by a reactor or a tank with a frustum-shaped bottom, provided with a mechanical agitator that is designed to mix uniformly the solution to be treated.

The chemical physical treatment system utilizes the tendency of the components within the solution to bond with others, producing solid compounds that tend to settle.

Purification with such chemical physical treatment means 39 of a per se known type occurs by binding the components that are harmful for human health and for the environment with other substances that are capable of producing a salt that is inert with respect to the original component and is heavier than water, so as to collect it in sludge.

The filter press, which forms the solid waste disposal means 18, is therefore preset to receive sediments from:
the bottom of the first settling tank 47 of the line for treatment of the low-acidity current AWD,
the bottom of the first storage tank 48 of the clarified fluid of the line for treatment of the low-acidity current AWD,
the bottom of the second settling tank 54 of the line for treatment of the very low-acidity current AWDD,
the bottom of the reactor for chemical physical treatment 39.

In practice it has been found that the invention thus described solves the drawbacks noted in known types of apparatus for the treatment of wastewater originating from a process for production of photovoltaic cells and achieves the intended aim and objects.

In particular, the present invention provides an apparatus 10 which, by way of the redefinition of the wastewater to optimize their subsequent treatment, is based on the choice of the processes for the production of pure water with low water consumption (ion exchange resins instead of reverse osmosis) and suitable for reuse of all the diluted wastewater.

This choice is well-grounded, since the osmosis process generates, as mentioned above, a higher quantity of wastewater to be treated and has a much higher energy consumption; vice versa, the demineralization as described above, in steps of successive purity, optimizes both the volume of wastewater generated and the distillation.

Moreover, the present invention provides an apparatus 10 that allows optimum reuse of concentrated wastewater: the concentrated acid wastewater (AWC current) is used instead of sulfuric acid for the acidification process and the concentrated alkaline wastewater (CAWC current) is used instead of caustic soda for the alkalinization process.

In order to use all of the AWC current produced by the line, the system has an alkaline current deficit.

Further, all the CAWC current that arrives from the SDE machine is used in the scrubbers to suppress the acid exhaust gases; the choice has been made therefore to increase the pH of the solution that is present in the scrubbers and to change it more often, so as to:
consume all the AWC current, avoiding expensive disposal at an external company that is structured and authorized for this purpose,
reduce atmospheric emissions significantly,
reducing drastically the environmental impact of the company where the apparatus 10 is installed and operates;
generating a solid waste whose components are the only components that are present in the production process.

Moreover, the present invention provides an apparatus 10 that allows reuse of all the liquid wastewater produced by the auxiliary apparatuses.

In brief, therefore, the invention provides an apparatus 10 that is capable of reducing considerably the consumption of mains water, eliminate almost entirely the environmental impact of the production process of photovoltaic cells, thus freeing the company that adopts it from the strictest limitations set by local laws and from the requirement to rely on toxic waste disposal companies.

Moreover, the present invention provides an apparatus 10 for treating wastewater, particularly originating from a process 11 for producing photovoltaic cells or the like, that can be provided by means of known technologies.

The invention thus conceived is susceptible of numerous modifications and variations, all of which are within the scope of the appended claims; all the details may further be replaced with other technically equivalent elements.

The apparatus 10 is to be understood to be applicable also to processes for the production of cells from monocrystalline silicon as well as polycrystalline silicon.

Constructive variations of the hydraulic solutions of the components of the apparatus must be considered part of the patent.

The possibility to integrate all the auxiliary wastewater of the production site is considered part of the patent.

The possibility to apply the integrated system also in the production of cells from monocrystalline silicon must be considered part of the patent.

Other systems for filtration/dehydration of the produced sludge must be considered part of the patent.

The use of regenerating agents for the resin apparatuses of a different kind must be considered part of the patent.

Resins other than the ones used but employed with the same intention must be considered part of the patent.

In practice, the materials used, so long as they are compatible with the specific use, as well as the dimensions, may be any according to requirements and to the state of the art.

The disclosures in Italian Patent Application No. PD2008A000143 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-20. (canceled)

21. An apparatus for the treatment of wastewater, particularly wastewater originating from a process for the production of photovoltaic cells or the like, comprising:
a first line for the treatment of wastewater originating from said process, with a high level of acidity,
a second line for the treatment of wastewater with a low level of acidity,
a third line for the treatment of wastewater with a very low level of acidity,
a fourth line for the treatment of alkaline wastewater,
the wastewater that exits from said second line and third line being adapted to be sent to a purification line designed for filtering, obtaining pure water and ultrapure water, said pure water and said ultrapure water being adapted to be reused in the same production process from which said wastewater originates, in the associated exhaust gas suppression systems, and in other similar systems.

22. The apparatus according to claim 21, also comprising means for the disposal of solid waste.

23. The apparatus according to claim 21, wherein said first line for treatment of wastewater with high acidity level comprises:
first means for collecting said wastewater in a first recirculation trap,
first means for pumping toward first storage tanks,
means for transferring said current with high acidity level toward at least one of the other second, third and fourth lines.

24. The apparatus according to claim 21, wherein said second line for the treatment of wastewater with low acidity level comprises:
means for collecting said wastewater in a second recirculation trap,
second means for pumping toward first clarification means,
first filtration means,
first demineralization means.

25. The apparatus according to claim 21, wherein said third line for treatment of wastewater with very low acidity level comprises:
second means for collecting said wastewater in a third recirculation trap,
third means for pumping toward second clarification means,
second filtration means,
second demineralization means.

26. The apparatus according to claim 21, wherein said fourth line for treatment of alkaline wastewater comprises:
third means for collecting said wastewater in a fourth recirculation trap,
fourth means for pumping toward at least one storage tank,
means for a chemical physical treatment for purifying the stored wastewater.

27. The apparatus according to claim 21, wherein said line for purifying the water that exits from said demineralization means comprises a regenerable mixed-bed system with which a non-regenerable mixed-bed system is associated in series.

28. The apparatus according to claim 22, wherein said means for disposal of solid waste are constituted by a filter press.

29. The apparatus according to claim 21, comprising means for preparing and distributing a polyelectrolyte, means for preparing and distributing milk of lime, and distillation means.

30. The apparatus according to claim 29, wherein said distillation means are constituted by a series of evaporators, with which a discharge tank is associated for the concentrates that exit from the evaporators, a system for controlling the alkalinity of the solution in input to the distillation means, and an additional tank for storing distilled water, said distilled water being designed to be returned:
upstream of the clarification means of the low-acidity wastewater and very low-acidity wastewater,
to the means for preparing a polyelectrolyte,
to the means for preparing milk of lime.

31. The apparatus according to claim 24, wherein said first clarification means are constituted by a first static mixer, which has in series in output a first settling tank, followed by a storage tank for storing the clarified fluid that exits from the settling tank, the sediment deposited on the bottom of said settling tank being adapted to be sent to said filter press.

32. The apparatus according to claim 31, wherein said first filtration means, downstream of said first settling tank, are constituted by an assembly of at least two filters, each of which can be bypassed autonomously with respect to the other one, with 20-micron and 5-micron cartridges in series.

33. The apparatus according to claim 24, wherein said first demineralization means for said low-acidity current, clarified and filtered, are constituted by an assembly with four transit stages in series, wherein a first stage is constituted by a first column with activated charcoal, followed by a second stage constituted by a second column with cationic resins, followed by a third stage constituted by a third column with weak anionic resins, followed by a fourth stage constituted by a fourth column that contains strong anionic resins.

34. The apparatus according to claim 33, comprising two assemblies with four stages, of which alternately one is operating and the other one is in regeneration or standby.

35. The apparatus according to claim 25, wherein said second clarification means are constituted by a second static mixer, which has in series in output a second settling tank, followed by a storage tank for of the clarified fluid that exits from the settling tank, the sediment deposited on the bottom of said settling tank being adapted to be sent to said filter press.

36. The apparatus according to claim 35, wherein said second filtration means, downstream of said second settling tank, are constituted by an assembly of at least two filters, each of which can be bypassed autonomously with respect to the other, with 20-micron and 5-micron cartridges in series.

37. The apparatus according to claim 25, wherein said second demineralization means for said current with very low acidity, clarified and filtered, are constituted by an assembly with three transit stages in series, wherein a first stage is constituted by a first column with an activated charcoal bed, which can be modified with activated alumina, followed by a second stage constituted by a second column with cationic resins, followed by a third stage constituted by a third column with weak anionic resins.

38. The apparatus according to claim 37, comprising two assemblies with three stages, of which alternately one is operating and the other one is in regeneration or standby.

39. The apparatus according to claim 26, wherein said means for a chemical physical treatment for purifying the stored wastewater are constituted by a reactor or a tank with a frustum-shaped bottom provided with a mechanical agitator adapted to mix uniformly the solution to be treated.

40. The apparatus according to claim 35, wherein said filter press is adapted to receive sediments from:
the bottom of said first settling tank of the line for treatment of the low-acidity current,
the bottom of the first storage tank of the clarified fraction of the line for treatment of the low-acidity current,
the bottom of said second settling tank of the line for treating the current with extremely low acidity,
the bottom of said reactor for chemical physical treatment.
